(19) United States
(12) Patent Application Publication
(10) Pub. No.: US 2026/0299744 A1
(43) Pub. Date: Oct. 1, 2026

(54) SELECTIVE RENDERING OF GENERATIVE RESPONSE ENGINE OUTPUT

(71) Applicant: OpenAI OpCo, LLC., San Francisco, CA (US)

(72) Inventor: Brandon Walkin, San Francisco, CA (US)

(73) Assignee: OpenAI OpCo, LLC., San Francisco, CA (US)

(21) Appl. No.: 19/240,652

(22) Filed: Jun. 17, 2025

Related U.S. Application Data
(63) Continuation of application No. 19/092,394, filed on Mar. 27, 2025, now abandoned.

(51) Int. Cl. G06F 3/04815; G06F 3/04842

(52) U.S. Cl. CPC G06F 3/04815; G06F 3/04842

(57) ABSTRACT

In one aspect, a method includes receiving, by a front end to a generative response engine, a prompt from a user account; generating, by the generative response engine, at least a first portion of a response to the prompt, where the at least the first portion of the response includes a visual part of the response and a spoken text part that corresponds to the visual part of the response; sending, by the generative response engine to the front end, the at least the first portion of the response to the front end; rendering, by the front end, the visual part of the at least the first portion of the response by the front end in a graphical user interface and playing the spoken text that corresponds to the first portion of the response.

### CROSS-REFERENCE TO RELATED APPLICATIONS

This application is a continuation of and claims priority to U.S. application number Ser. No. 19/092,394, filed on Mar. 27, 2025, entitled SELECTIVE RENDERING OF GENERATIVE RESPONSE ENGINE OUTPUT, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present technology.

FIG. 2A, FIG. 2B, FIG. 2C, FIG. 2D, FIG. 2E, FIG. 2F, and FIG. 2G illustrate an example use case for selective rendering of generative response engine output in accordance with aspects of the present technology.

FIG. 3 illustrates a method for selectively rendering generative response engine output in accordance with some aspects of the present technology.

FIG. 4 illustrates a process for interacting with an interface to prompt a generative response engine in accordance with some aspects of the present technology.

FIG. 5 illustrates a method for interacting with an interface rendered by a front end to a generative response engine in accordance with some aspects of the present technology.

FIG. 6 is a block diagram illustrating an example machine-learning platform for implementing various aspects of this disclosure in accordance with some aspects of the present technology.

FIG. 7A, FIG. 7B, and FIG. 7C illustrate an example transformer architecture in accordance with some aspects of the present technology.

FIG. 8 shows an example of a system for implementing some aspects of the present technology.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

However, because of their remarkable linguistic prowess, these generative response engines can output lengthy responses including large amounts of information that may be relevant to a user's prompt, where the only constraint on the size of the output is a limitation of the number of tokens that the generative response engine can output for a single prompt.

As an example, a user account may provide a prompt asking, “When is Tax Day?” The generative response engine may output a lengthy response based on a corpus of information about the history of Tax Day and other information pertaining to Tax Day. It can be inefficient for a user to sift through this information to determine the date of Tax Day or which day of the week this year's Tax Day falls on. In another example, a user account can provide a prompt requesting the history of Mesopotamia. The generative response engine can output a large block of text describing the history, which may or may not be organized into sub-sections.

However, it may be more beneficial to the user to be able to view the requested content in a more condensed or interactive view. This could, for example, include maps, interactive timelines, or content that is explorable by a number of different topics, such as dates, civilizations, notable innovations, or conflicts.

The present technology aims to address these and other challenges associated with generating long-form textual output by facilitating the selective rendering of content into a more easily digestible format that highlights key information contained in the textual output.

For example, the format for rendering content can be a slideshow, video, audio output following a generated script, or interactive content provided via a widget. Thus, disclosed systems and methods can facilitate dynamic, multi-modal output of information from the generative response engine, thereby improving user experience with the front end to the generative response engine.

To achieve these improvements, systems and methods include outputting, by the generative response engine audio and/or visual parts of a response that can be rendered by the front end to provide content of a type and format determined based on a prompt. For example, based on a prompt and/or an intent of the prompt, the generative response engine can output a response of a particular type that is beneficial for visualizing the response or for conveying a particular type of information included in the response. As an example, the generative response engine can output a response to the prompt, where the visual part of the response includes markup language to be rendered by the front end to display a slideshow providing a summary of the response content. In some examples, the visual part can include “display” text that is a subset of the full text of the response output by the generative response engine. In some examples, the generative response engine can output a script to be output in sync with the slideshow. Using a speech to text tool, the front end can cause the script to be output as audio that progresses as the slideshow progresses. In another example, the visual part of the response can include executable code that can be executed by a widget of the front end to provide an interactive interface for exploring the content of the response (e.g., a quiz about the response content, a playable game, etc.).

Further, systems and methods described herein can not only facilitate an efficient display of information but can also provide an interface through which a user can interact with the generative response engine or with content of a response using multiple modalities. For example, a user may prompt the generative response engine to explain different chemical functional groups. Based on the prompt, the generative response engine can output a visual part of the response that can include code able to be rendered by the front end to generate an interactive interface through which a user can, for example, display a set of functional groups selectable by the user to learn more about the selected functional group. In this example, a user may click on an ester displayed in the interface. The front end may determine, based on one or more pixels selected by a cursor, that the user clicked the diagram of the ester and may generate a textual prompt. In another example, the user may say “tell me about esters,” from which the front end generates a textual prompt (e.g., using speech to text conversion functionality. The textual prompt can be transmitted to the generative response engine such that the generative response engine outputs a response with a visual part, where the response content is information about the ester functional group and the visual part can be rendered by the front end to provide, for example, a video, an interactive interface, a slideshow, a diagram, and the like.

Accordingly, aspects of the disclosed invention can facilitate dynamic, multi-modal display of information that can, in some examples, distill or highlight content of the generative response engine output. Thus, the experience of the user is improved by providing and summarizing key information or providing images or illustrations without needing additional prompts by the user to the generative response engine. Further, disclosed systems and methods allow the user to multi-modally interact with displayed or dictated content through voice commands, text, interaction with an interface, and the like.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

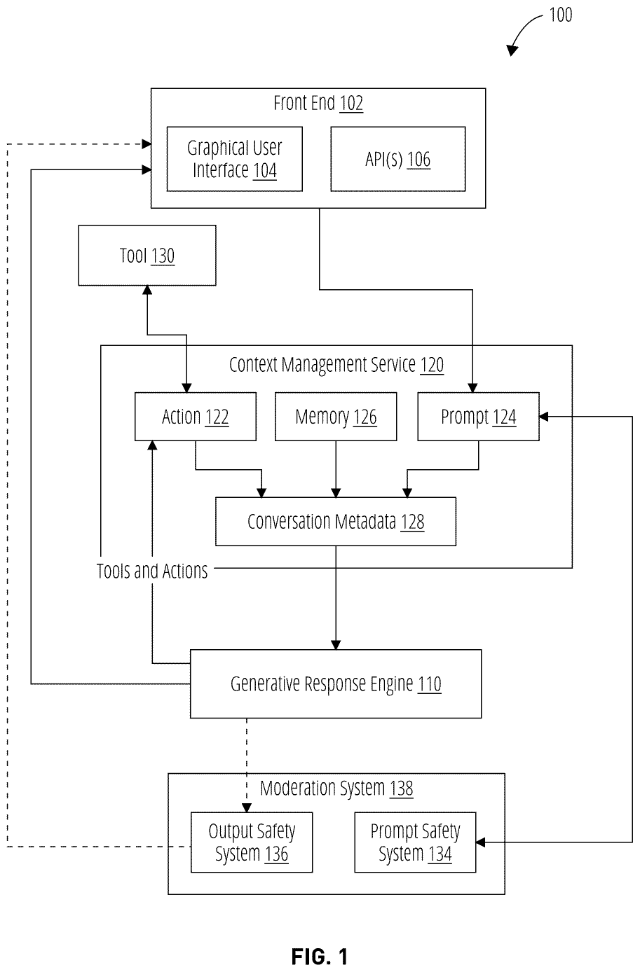

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., autoregressive transformer architecture) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110. For example, a language model is generally configured to accept text, but when the generative response engine is a multi-modal generative response engine, the front end 102 can accept voice and images/video.

In some aspects, front end 102 can be an interface to accept any input types as part of the prompt, and downstream services can determine which generative response engine or collection of generative response engines are best suited to respond to the prompt.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the graphical user interface 104 might be configured to provide a system prompt along with a user-provided prompt. A system prompt is hidden from the user account and is used to set the behavior and guidelines for the generative response engine. It can be used to define the AI's persona, style, and constraints. There can be levels of system prompts. A highest level of a system prompt might be provided by the generative response engine 110 provider and its meant to establish policies for the behavior of generative response engine 110. This highest level os system prompt should be prohibited from being edited. A customization system prompt can be used to customize the behavior of the generative response engine and is often provided through an API call, or provided by a user account when creating a customized version of generative response engine 110. A still lower level of system prompt might include hidden information about a task. This can include chain-of-thought from a reasoning model, or context about an application the generative response engine 110 is working with to complete a task. Accordingly, the graphical user interface 104 does not always display all of the output of the generative response engine.

The graphical user interface 104 is also configured to display the responses from the generative response engine, which might include text, code snippets, images, or interactive elements.

In some aspects, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document.

In some aspects, the generative response engine 110 can provide instructions memory 126 to record facts in a personalization notepad, and front end 102 can be configured to notify the user account that a memory was created.

As noted above, the front end 102 can also provide one or more application programming interfaces (API(s)) 106. APIs enable developers to integrate the generative response engine's capabilities into external applications and services. They provide programmatic access to the generative response engine, allowing for customized interactions and functionalities. While APIs 106 are shown as part of a front end 102, this illustration takes the liberty of locating API 106 in front end 102 to refer to points of access to generative response engine 110 (i.e., graphical user interface 104 and APIs 106 are points of access and generative response engine 110 sends and receives messages to them in similar ways). In reality, API 106 endpoints are located at context management service 120.

The APIs 106 can accept structured requests containing prompts, context, and configuration parameters. For example, an API can be used to provide prompts and divide the prompt into system prompts and user prompts. In some aspects, the APIs 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the AI assistant service 100's content moderation decision-making. In the case of the moderation API and others, the API might give access to services other than the generative response engine.

For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a context management service 120. The function of context management service 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt. For example, an action can be to call tool 130 or even another generative response engine 110.

Prompt 124 is the request or command provided by the user account through front end 102. In some aspects, prompt 124 can be further supplemented by a system prompt and other information that might be included by graphical user interface 104 or API 106 or associated with a custom generative response engine 110. In some aspects, prompt 124 can even be modified or enhanced by generative response engine 110 as addressed further below.

Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. The actors in the conversation thread can be labeled so that generative response engine 110 can review the turns of the conversation.

Generally, prompt 124 will include an entire conversation thread, but in some instances, prompt 124 might need to be shortened if it exceeds a maximum accepted length (generally measured by a number of tokens).

Context management service 120 can also route prompts and response through moderation system 138. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions. In some aspects, memory 126 can also include synthesized concepts extracted from past conversation threads, and memory 126 can also encompass the ability of generative response engine 110 to search through past interactions to find relevant information to a current conversation thread.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from context management service 120) and generates outputs. In some aspects, the generative response engine is a generative transformer, or autoregressive transformer, but it could utilize other architectures. In some examples, the transformer is multi-modal transformer that can use audio tokens (or embeddings thereof), visual tokens (or embeddings thereof), and language (or embeddings thereof) as needed.

A core feature of the generative response engine 110 is to generate content in response to prompts. The generative response engine 110 is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. Two features of the autoregressive transformer that result in this functionality are that the autoregressive transformer might use only the decoder part of the transformer architecture and that it utilizes self-attention. By utilizing the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some aspects, the generative response engine 110 can generate multiple possible responses before presenting the final one. The generative response engine 110 can generate multiple responses based on the input, and these responses are variations that the generative response engine 110 considers potentially relevant and coherent.

In some aspects, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some aspects, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ) , and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user. In another example, some generative response engine 110 are reasoning models, which are generative response engine 110 that are configured to output a raw chain-of-thought before preparing a final response to a prompt. The raw chain-of-thought might not be presented to a user account or application calling an API. Instead, another generative response engine 110 might summarize the raw chain-of-thought into a more consumable and useful output for the user account or application.

In some aspects, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some aspects, the responses might be returned by way of context management service 120.

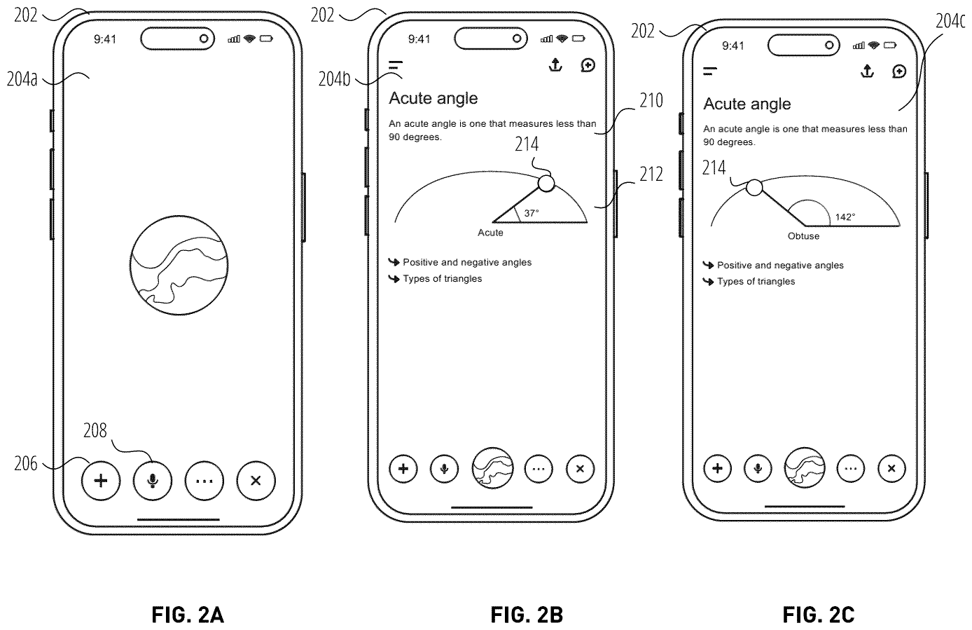

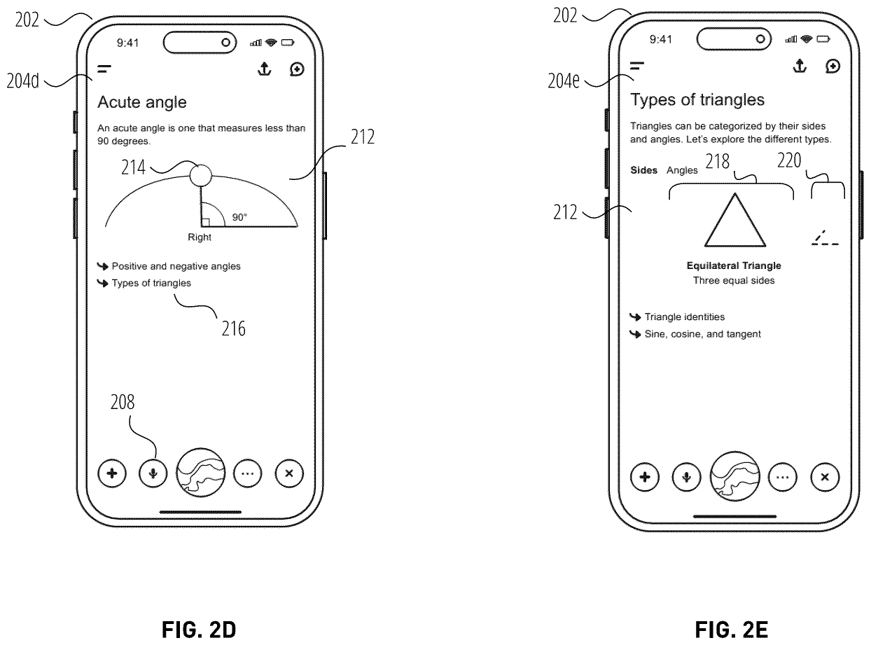

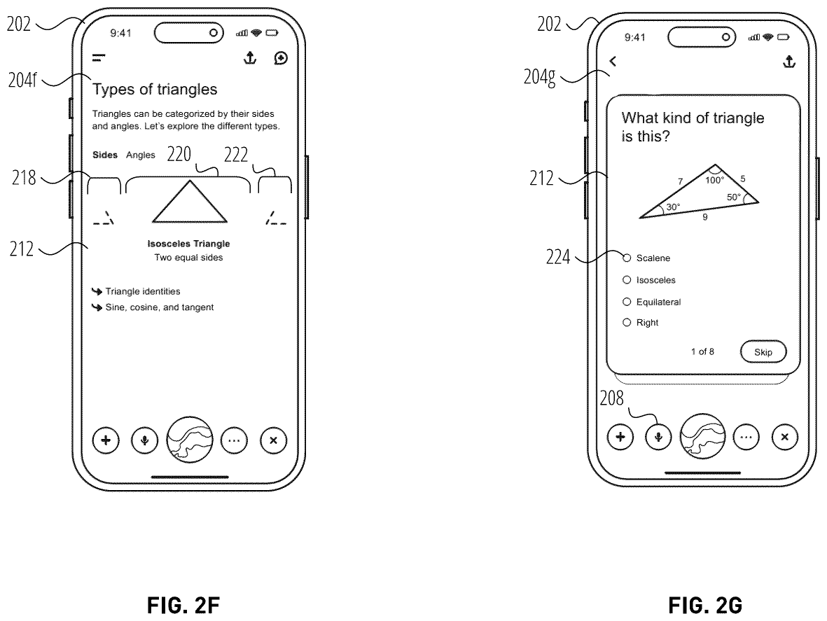

FIG. 2A, FIG. 2B, FIG. 2C, FIG. 2D, FIG. 2E, FIG. 2F, and FIG. 2G illustrate example displays that may be rendered on a user device interacting with a generative response engine according to aspects of the present disclosure. The illustrations of FIG. 2A, FIG. 2B, FIG. 2C, FIG. 2D, FIG. 2E, FIG. 2F, and FIG. 2G intended to provide non-limiting examples of functionality of aspects of the present disclosure.

FIG. 2A illustrates a device 202 of a user associated with a user account. Device 202 may include a screen or touchscreen for displaying an interface 204a. In some examples, device 202 can also include one or more additional input devices (not shown), which can include a microphone, a keyboard, a mouse, etc., and one or more additional output devices (not shown), which can include a speaker. The user can, via interface 204a, interact with front end 102 of generative response engine 110.

Interface 204a can be displayed, for example, as a voice input screen in an application stored on device 202 and associated with generative response engine 110. In another example, interface 204a can be displayed in a web browser of device 202 as voice input page of a website interacting with generative response engine 110.

Interface 204a can enable the user to input prompts to front end 102 and to receive responses from generative response engine 110, which are rendered for display in interface 204b and interface 204c by front end 102. In some examples, the user can input a prompt by selecting button 206, which may open a chat box or textbox for inputting a prompt (e.g., using a keyboard). In other examples, the user can input a prompt by selecting button 208 to control a microphone of device 202 to accept audio inputs or to mute the microphone. When the microphone is active, it can record a spoken prompt from the user. Front end 102 can use speech to text functionality to generate a textual prompt from the spoken prompt and provide the textual prompt to generative response engine 110 or it can stream the audio that includes the spoken prompt to generative response engine 110.

In the example illustrated in FIG. 2A and FIG. 2B, the prompt may be a typed or spoken prompt asking, “What is an acute angle?”

Front end 102 can provide the prompt to generative response engine 110, which outputs a response based on the prompt (e.g., information about acute angles). In some examples, the response may include content (e.g., information relating to the prompt) including an audio part, and a visual part. The visual part may include markup language or executable code to be rendered by front end 102 to display content of the response on device 202. The visual part can, in some examples, include an interactive component or a video played by front end 102. In some examples, generative response engine 110 can output a script (e.g., the audio part) to be spoken to the user (text-to-speech) or audio including a spoken script associated with the visual part, where the script includes explanation of the content of the visual part.

Generative response engine 110 can transmit the response, including the visual part and the audio part, to front end 102.

FIG. 2B illustrates device 202 displaying interface 204b. Interface 204b can be generated as a result of front end 102 rendering the visual part of the response. Front end 102 can also play an audible part of the response will displaying the visual part of the response. In some examples, interface 204b can include a first portion for displaying the visual part of the response (e.g., interactive component 212) and a second portion for displaying text that at least summarizes the spoken text (e.g., definition 210). In some examples, interface 204b can include a portion or sub-set of content of the response content. The portion or sub-set of content can include, in this example, a definition 210 and an interactive component 212. In some examples, generative response engine 110 can be post-trained to output certain visual elements in response to certain types of prompts. In this example, generative response engine 110 can output a brief definition and an interactive component for illustrating the mathematical concept of an acute angle.

In some examples, generative response engine 110 can output three streams of tokens: audio tokens (e.g., tokens for the audio part); display tokens (e.g., tokens for the visual part); and full text transcript tokens (e.g., tokens making up the full text transcript of the response).

The audio tokens and the display tokens can be output by front end 102 to device 202 to form interface 204b and its accompanying audio. In some examples, one or more of the output token streams can include a time offset, such that output audio can be synced with presentation of particular elements of the visual part. In some examples, the display tokens can be tokens forming executable code to render an interface and audio tokens can form audio output to accompany the displayed interface. In some examples, audio tokens and display tokens can each be a subset of the full text transcript tokens.

Front end 102 can, in some examples, render interface 204b by running markup language or executing executable code of the visual part (e.g., the display tokens) of the response. In some examples, front end 102 can call a tool or widget for rendering interactive component 212. Interactive component 212 can include a slider 214 that is moveable through user interaction with interface 204b. Further, manipulation of slider 214 in interactive component 212 can cause front end 102 to generate additional prompts to generative response engine 110 for changing the displayed screen. In another example, the output visual part can include a deterministic program with instructions for how to change interface 204b in response to user input via interactive component 212. In some examples, the visual part can be rendered by front end 102 to display a high-level summary based on the response. The high-level summary can be formatted into a set of content elements, where a content element is associated with content of the response associated with a sub-topic. In some examples, the high-level summary can be a subset of text of the text of the full response output by generative response engine 110.

In some examples, device 202 can output (e.g., via a speaker or using closed captioning) the audio part (e.g., the audio tokens) of the response corresponding to the visual part of the response. In some examples, the audio part can include text (e.g., a script) that is the same as, or related to, text displayed as a result of rendering, by front end 102, the visual part of the response. The text can be output via the speaker using a text to speech function of front end 102. In some examples, the text of the audio part of the response can include instructions for interacting with interactive component 212. Instructions can be, for example, “Touch the screen to move the slider and explore different types of angles.” Accordingly, interactive component 212 can be used to illustrate content of the response (e.g., illustrate definition 210), and also to enable the user to view related topics.

As an example, the user may manipulate the interactive component 212 by moving slider 214 to the left along the arc, thereby increasing the size of the displayed angle. In this example, front end 102 may receive data associated with this manipulation (e.g., an ordered set of pixels), and based on the location and sequence of the pixels, front end 102 can generate a textual prompt for providing to generative response engine 110, in conjunction with a thread of the initial prompt, and response, to cause generative response engine 110 to output a response based on the user's manipulation of interactive component 212. For example, the prompt generated by front end 102 may cause generative response engine 110 to output a second response including a second audio part and a second visual part.

In another example, front end 102 can capture sequential screenshots, or a video, of interface 204b and provide the screenshots or video to generative response engine 110.

Generative response engine 110 can determine a change to interface 204b based on analysis of the screenshots or video at a point in time before the user manipulated slider 214 and a point in time after the user manipulated slider 214. This change in the appearance of interface 204b can be used as input to generative response engine 110 to output the second audio part and the second visual part.

In another example, the first visual part can be a deterministic program for execution by front end 102. In this example, as the user interacts with interactive component 212, the deterministic program can respond accordingly (e.g., by displaying the second visual part and the second audio part which were previously output by generative response engine 110 as part of the deterministic program.

FIG. 2C illustrates interface 204c which may be displayed on device 202 based on front end 102 rendering the second audio part of the second response and the second visual part of the second response.

As shown in FIG. 2C, the result of the user moving slider 214 to the left is that interactive component 212 now displays an obtuse angle. As discussed above, the manipulation of interactive component 212 can cause front end 102 to generate a prompt causing generative response engine 110 to output the second visual part and second audio part, or generative response engine 110 can identify the change in appearance of the interface from interface 204b to interface 204c and can output the second audio part and the second visual part based on that change. In another example, the second audio part and the second visual part can be part of a deterministic program output by generative response engine 110 in response to the initial prompt from the user, such that the user can manipulate interactive component 212 and receive the second audio part and the second visual part as the program is executed by front end 102. In yet another example, when responding to the original prompt, generative response engine 110 can output an entire script including the first audio part and the second audio part. Based on a determination of the user manipulation of slider 214 by front end 102 or generative response engine 110, the script can be advanced to the second audio part, which is linked with the particular manipulation of slider 214.

The user can then further interact with content output by generative response engine 110 by manipulating slider 214 to a middle position (e.g., showing a right angle in interactive component 212), or by providing a verbal or text prompt like “Are there any other kinds of angles?” In some examples, in which the second visual part and second audio part are part of a video, the output audio and output visual display may automatically advance once the second audio part and second visual part are output.

FIG. 2D illustrates interface 204d displayed by device 202. Interface 204d may be displayed in response to the video and audio output by generative response engine 110 advancing automatically, or may be output by front end 102 or generative response engine 110 in response to the user manipulating slider 214. In another example, interface 204d can be generated in response to the user providing a verbal or textual prompt via device 202.

Interface 204d can be a third visual part associated with a third audio part output by generative response engine 110 either as part of the response to the initial prompt, as part of a response to a prompt generated by the user's interaction with content of interface 204d, or as part of a response to a prompt provided by the user (e.g., in text or by voice) via generative response engine 110.

The user can further interact with interface 204d by selecting a menu item 216, which may be part of a listing of related topics. For example, one or more visual parts output by generative response engine 110 can include additional suggested topics related to the user's prompt. In some examples, an audio part can include verbal suggestions, to be output by front end 102 via device 202, such as “Would you like to learn about types of triangles?”

By either selecting (e.g., via a touchscreen of device 202) menu item 216 or by verbally responding to an audio suggestion, the user can cause front end 102 to generate a textual prompt and provide the textual prompt to generative response engine 110. For example, selecting menu item 216 of interface 204d, can cause front end 102 to generate a textual prompt or to provide the topic (e.g., Types of triangles) as a prompt to generative response engine 110. In another example, if a user verbally provides a prompt, front end 102 can use a speech to text function to generate a textual prompt from the verbal prompt and provide the textual prompt to generative response engine 110. In yet another example, as described above, front end 102 can provide screenshots from device 202 or a video of the screen of device 202 to generative response engine 110. Based on a difference between video frames or screenshots, generative response engine 110 can output a response based on the user's manipulation of interactive component 212.

FIG. 2E illustrates an example interface 204e shown on device 202, which may be output, for example, in response to the user selecting menu item 216 (e.g., Types of triangles). Generative response engine 110 may output a visual part and an audio part based on the prompt provided in response to the user's selection of menu item 216.

In this non-limiting example, the visual part can include (in interactive component 212) a slideshow consisting of one or more panels (e.g., first panel 218 and second panel 220). In some examples, reinforcement learning can be used to post-train generative response engine 110 to output particular elements in response to certain prompts. For example, when a subject of output has a set of sub-topics, generative response engine 110 can be post trained to provide a visual part of the response with interactive elements, when elements are associated with a sub-topic. In some examples, generative response engine 110 can output other interactive content, such as a timeline, graph, or other visual element for providing response content on a particular subject.

In this example, generative response engine 110 can output a visual part to be rendered by front end 102 to provide interactive component 212 including a slideshow of panels (e.g., first panel 218 and second panel 220). The slideshow and accompanying script, which is provided as the audio part and output by front end 102 using a speaker of device 202, may advance automatically as the script progresses, or a user can interact with the slideshow or provide text or verbal commands (e.g., proceed to the next slide).

As first panel 218 is displayed on interface 204e, front end 102 can use text to speech functionality to output audio associated with the audio part corresponding to the visual part.

For example, as the audio part, generative response engine 110 can output a script to be output, using speech to text functionality, by front end 102 as first panel 218 is displayed. Additional elements of interactive component 212 may also be displayed via interface 204e either in part or in whole. For example, as shown in FIG. 2E, interface 204e can show (e.g., in dotted line) second panel 220, thereby indicating that there is an additional element for the user to interact with.

In some examples, the user can manipulate interactive component 212 as the audio part is being output by device 202, thereby interrupting the audio part. As an example, based on the user sliding first panel 218 to the left and causing second panel 220 to be displayed, as shown in interface 204f of FIG. 2F, front end 102 can stop outputting the audio part output by generative response engine 110.

In addition to ceasing output of the audio part, front end 102 can determine, for example, that the user has advanced the slideshow to second panel 220. In response, front end 102 can skip to a section of the audio part associated with second panel 220 and output that section (e.g., using text to speech functionality). In another example, front end 102 may determine, e.g., based on the user input via a touchscreen of device 202, that the user has advanced the slideshow to second panel 220 and may generate a textual prompt based on the topic displayed in second panel 220 (e.g., “What is an isosceles triangle?”). Front end 102 can provide the textual prompt to generative response engine 110 such that generative response engine 110 outputs an audio part based on the textual prompt. In this example, front end 102 can output the audio part associated with the textual prompt while the user is viewing second panel 220.

The user can use interactive component 212 to navigate between panels of the slideshow (e.g., first panel 218, second panel 220, and a third panel 222). In some examples, the user can provide a verbal command to advance the slideshow (e.g., “Next slide” or “Next panel”) or can provide a verbal command requesting information about topics in the other slides (e.g., the command “Can we review equilateral triangles?” can cause either front end 102 or generative response engine 110 to navigate the display to first panel 218).

FIG. 2G illustrates an example interface 204g displayed by device 202 in response to a user account prompting generative response engine 110 for a quiz. For example, the user can hold button 208 to initiate a microphone of device 202 such that the user can verbally provide a prompt such as, “Can you quiz me on that?” or “Can you make me a quiz on triangles?”

Front end 102 can use speech to text functionality to generate a textual prompt based on the verbal prompt provided by the user. Front end 102 can provide the textual prompt to generative response engine 110. In some examples, generative response engine 110 can also receive a conversation thread or other context from context management service 120 or front end 102. For example, if the user provides a prompt, “Can you quiz me on that?” generative response engine 110 can receive the conversation thread or context information indicating what “that” refers to.

In response to the textual prompt, generative response engine 110 can output the visual part as a widget, application, or other executable code for rendering by front end 102 to provide an interactive quiz as interactive component 212. In some examples, generative response engine 110 can output an audio part corresponding with the quiz. The audio part can be an audio file or script to be output by device 202 using text to speech functionality of front end 102. In some examples, the audio part can include dictation of the questions and answer options and can include answer explanations.

In some examples, front end 102 can receive, from a user account, a prompt as an audio file, text, or image, and can provide the prompt directly to generative response engine 110. Based on the prompt, generative response engine 110 can generate output of a particular format. For example, in response to an audio prompt, generative response engine 110 can output, at least a portion of a response, as an audio file. In other examples, generative response engine 110 can receive a prompt and output a response in a particular format (e.g., text, audio, image, etc.) based on the prompt.

In some examples, the user can interact with the quiz multimodally. For example, to answer a question the user can select a radio button 224 or can verbally provide an answer by saying one of the answer options (e.g., by saying “Scalene”). If the user selects or says a wrong answer, the audio part can include a prompt to the user to try again or select another option.

Again, the user can answer by either interacting with interactive component 212 via the touchscreen of device 202 or by verbally providing an answer.

As discussed with reference to the examples illustrated in FIG. 2A, FIG. 2B, FIG. 2C, FIG. 2D, FIG. 2E, FIG. 2F, and FIG. 2G, aspects of the present disclosure can facilitate selective rendering of generative response engine output. In addition to or instead of outputting long-form content, generative response engine 110 can output audio and visual parts for rendering portions of the long-form content in an easily digestible format to facilitate the user's understanding of a subject.

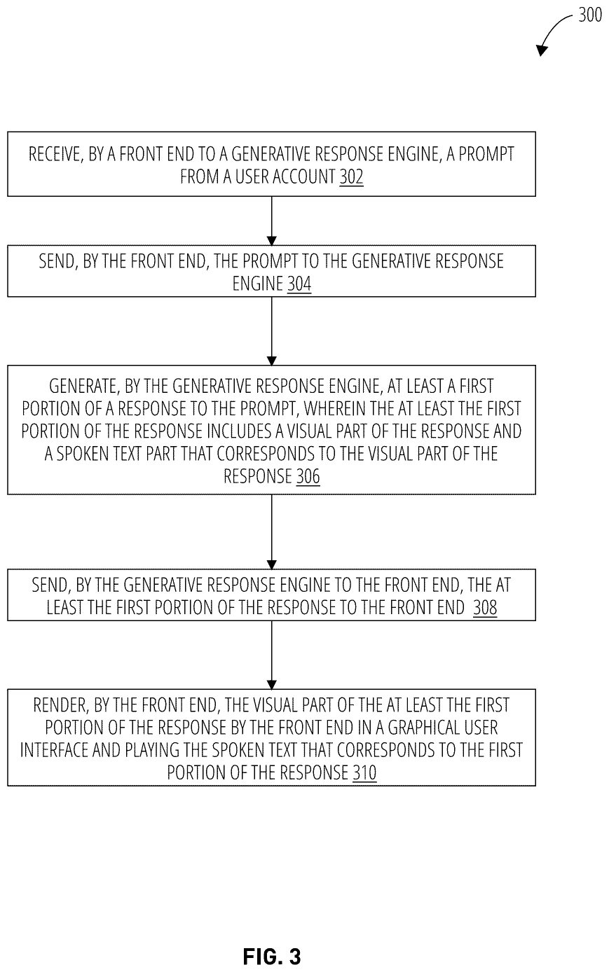

FIG. 3 illustrates an example method 300 for selectively rendering generative response engine output in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

In block 302, method 300 includes receiving, by a front end to a generative response engine, a prompt from a user account. For example, front end 102 to generative response engine 110 may receive a prompt from a user account. In some examples, the generative response engine is a multi-modal generative response engine, and can receive text, audio, or images as part of the prompt. In some examples, the generative response engine is configured to receive or output text, images, and/or audio. In some examples, the generative response engine is a generative pre-trained transformer.

In block 304, method 300 includes sending, by the front end, the prompt to the generative response engine. For example, front end 102 can send the prompt to generative response engine 110.

In block 306, method 300 includes generating, by the generative response engine, at least a first portion of a response to the prompt. For example, generative response engine 110 can generate at least a first portion of a response to the prompt. The at least the first portion of the response can include a visual part of the response and a spoken text part that corresponds to the visual part of the response. In some examples, the visual part of the response is provided in markup language to be rendered by the front end. In another example, the visual part of the response is a video to be played by the front end. The spoken text part may be provided as text to be converted to speech and played by the front end. In some examples, the spoken part is provided as audio to be played by the front end.

In some examples, generative response engine 110 can determine an intended response type of the prompt and can generate the at least the first portion of the response to include content of the response in a format of the intended response type. For example, different prompts may best be responded to using content in different formats. Different formats can include audio, images, videos, interactive programs or widgets, timelines, maps, text, lists, and the like. As discussed above, generative response engine 110 can be post-trained (e.g., using reinforcement learning) to determine which format is best suited for responding to a particular prompt. For the determined response type, generative response engine 110 can output a type of display for displaying the visual part of the at least the first portion of the response based on the intended response type. For example, a type of display can include a collaborative surface for displaying text or images. Generative response engine can output the visual part of the at least the first portion of the response for rendering a display by front end 102, where the display comprises the content formatted in the type of display.

Output of generative response engine 110 can include, for example, executable code for rendering interactive content, including at least the first portion of the response, such that the user account can multimodally interact with the interactive content. The type of visual part rendered by executing the executable code can be based on, for example, the intended response type of the prompt. In one example, the executable code for rendering interactive content can include markup code of a series of panels that can be paged through (e.g., as shown in FIG. 2E and FIG. 2F). In another example, the executable code can be code for a program.

In block 308, method 300 includes sending, by the generative response engine to the front end, the at least the first portion of the response to the front end. For example, generative response engine 110 may send the at least the first portion of the response to front end 102. In some examples, sending the at least the first portion of the response to the front end includes streaming the at least the first portion of the response to the front end as it is generated. In some examples, based on the determination of a type of display, generative response engine 110 can cause front end 102 to render the type of display in an interactive interface.

In block 310, method 300 includes rendering, by the front end, the visual part of the at least the first portion of the response by the front end in a graphical user interface and playing the spoken text or audio that corresponds to the first portion of the response. For example, front end 102 can render the visual part of the at least the first portion of the response by the front end in a graphical user interface and can play the spoken text that corresponds to the first portion of the response.

In some aspects, the first portion of the response includes instructions to the front end to display the visual part of the response in a first state at a first time that corresponds to a first spoken text part, and instructions to progress the visual part of the response to a second state at a second time that corresponds to a second spoken text part. Accordingly, front end 102 can, based on the instructions, provide the visual part with synchronized spoken text parts corresponding to different displays of the visual part. For example, referring again to FIG. 2E and FIG. 2F, a first spoken text part can be associated with first panel 218 and can be output by front end 102 as first panel 218 is displayed as in interface 204e. At a second time, either automatically (e.g., after the first spoken text part is completed) or based on the user advancing to second panel 220, front end 102 can output the second spoken text part corresponding to second panel 220 (e.g., as displayed in interface 204f).

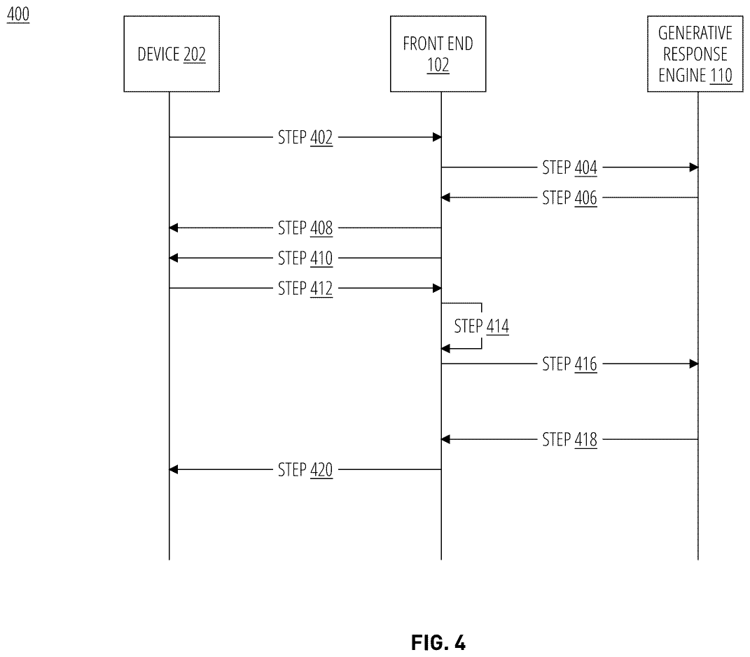

FIG. 4 illustrates a diagram of a process 400 for responding to user interaction with the visual part of the at least first part of the response in accordance with some aspects of the present technology. Although the example process depicts a particular sequence of steps, the sequence may be altered without departing from the scope of the present disclosure. For example, some of the steps depicted may be performed in parallel or in a different sequence that does not materially affect the function of the process. In other examples, different components of an example device or system that implements the routine may perform functions at substantially the same time or in a specific sequence.

At step 402, a user account can input a prompt via device 202, which is received by front end 102. For example, front end 102 can be a component of an application stored on device 202 for interacting with generative response engine 110. In another example, front end 102 can be accessed via a web browser of device 202.

At step 404, front end 102 may provide the prompt to generative response engine 110.

At step 406, generative response engine 110 may output a response to front end 102. In some examples, the response can be streamed to front end 102 such that tokens output by generative response engine 110 are provided in sequence to front end 102 as they are output by generative response engine 110. The response may include a visual part and a spoken text part.

At step 408, front end 102 can render the visual part for display by device 202. For example, the visual part output by generative response engine 110 can be markup language or executable code such that rendering or execution of the visual part causes device 202 to display an interface (e.g., any of interfaces 204a, 204b, 204c, 204d, 204e, 204f, or 204g). In this example, the interface displayed by device 202 may have an interactive component displaying two or more elements, where each element is associated with a sub-topic related to a topic of the prompt.

At step 410, front end 102 can cause device 202 to output (e.g., via a speaker of device 202) the spoken text part. The spoken text part can include content associated with the topic of the prompt. In some examples, the spoken text part can include content related to a sub-topic associated with a first element of the interactive display.

At step 412, device 202 may receive input from the user (e.g., an interaction with the interactive component of the visual part), which is communicated to front end 102. In some examples, this interaction can include a selection of a second element of the interactive display before the spoken text part is output in its entirety by device 202. For example, the user can interrupt the spoken part pertaining to a first sub-topic by selecting a different sub-topic. In some examples, the user can also interrupt the spoken part by providing a voice prompt or voice command.

At step 414, in response to receiving the interruption via device 202, front end can cease output of any remainder of the spoken text part that has been received at front end 102 from generative response engine 110. Front end 102 can also generate a prompt based on the received interruption. For example, front end 102 can generate a textual prompt requesting information on the selected sub-topic. In another example, front end 102 can use speech to text functionality to generate a textual prompt including content of the voice prompt or voice command. In another example, front end 102 can provide the interruption itself (e.g., text, an audio file of a verbal interruption, or a screenshot of the interface in response to an interaction) to generative response engine 110 as the prompt.

In some examples, during operation, front end 102 can collect screenshots of the interface displayed by device 202. Front end 102 may transmit all or a subset of these screenshots to generative response engine 110. For example, front end 102 can stream screenshots to generative response engine 110 (e.g., at a rate of one frame per second, three frames per second, etc.) such that generative response engine 110 can compare screenshots taken at different times to determine a change in the appearance of the interface. As an example, front end 102 can capture a screenshot at a time to in which the interface displays a first element in an interactive component. The interface may also display other, un-selected elements associated with other topics. An un-selected element can be, for example, displayed with lower opacity than a selected element or in greyscale, or any other means of de-emphasizing a visual element. At a subsequent time ti the user may select one of the other elements (e.g., by tapping the other element via the touchscreen of device 202), which may now be displayed in full color or full opacity in the interactive element. Front end 102 can capture screenshots at times to and ti and provide these screenshots to generative response engine 110 thereby indicating that a change has been made in the appearance of the interface.

At step 416, front end 102 can provide the prompt and/or screenshots to generative response engine 110. In some examples, in addition to the prompt and/or screenshots, generative response engine 110 can access a thread including the previous prompt and the response. The thread provides context for outputting a response (e.g., a next spoken text part associated with the selected sub-topic).

At step 418, generative response engine 110 can output a response based on the prompt and/or the detected change derived from the screenshots. For example, based on the screenshots indicating the selection of a sub-topic, generative response engine 110 can output, to front end 102, a spoken text part associated with the sub-topic.

At step 420, front end 102 can cause the spoken text part associated with the sub-topic to be output by device 202. In this manner, the user can interact with elements of the interface and be provided with audio content associated with each element and can interact with the interface to receive both visual and audio output associated with a prompt.

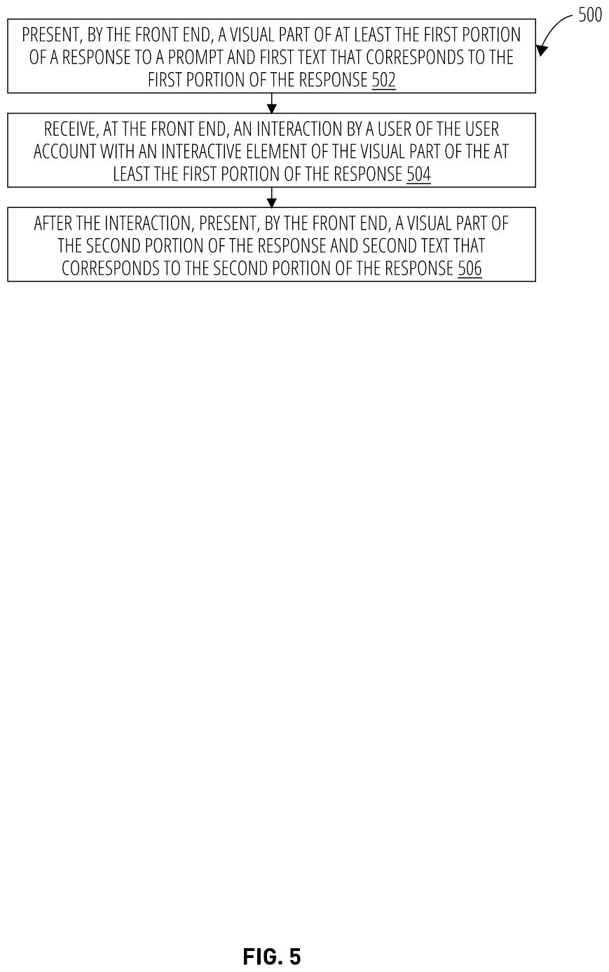

FIG. 5 illustrates an example method 500 for interacting with an interface rendered by a front end to a generative response engine in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

In block 502, method 500 includes presenting, by the front end, a visual part of at least the first portion of a response to a prompt and first text that corresponds to the first portion of the response. For example, front end 102 can cause device 202 to display the visual part of a first portion of a response output by generative response engine 110 in response to a prompt.

The visual part can be displayed in a graphical user interface.

In block 504, method 500 includes receiving, at the front end, an interaction by a user of the user account with an interactive element of the visual part of the at least the first portion of the response. For example, front end 102 can receive an interaction with an interactive element of the visual part (e.g., through a user interaction with device 202).

In some examples, the interaction by the user can be a selection of a portion of text (e.g., a portion of text associated with a related topic or sub-topic). Front end 102 can receive a selection of a segment of the at least the first portion of the response displayed via the graphical user interface. Front end 102 can determine contents of the segment based on an area of pixels selected by the user account interacting with the graphical user interface. For example, front end 102 can determine a segment of selected text, a selected menu option, or a selected image or icon.

Front end 102 can generate a second prompt based on the contents of the segment. For example, front end 102 can generate a textual prompt based on the contents of the segment and provide the textual prompt to generative response engine 110. In another example, front end 102 can provide a textual prompt specifying to generative response engine 110 which pixels of the graphical user interface were selected by the user. In response to the second prompt, front end 102 can receive a second output from generative response engine 110 based on the second prompt. The second output can include a second response having a visual part and an audio, or spoken text, part.

In block 506, method 500 can include, after the interaction, presenting, by the front end, the visual part of the second portion of the response and second text that corresponds to the second portion of the response. In some examples, front end 102 can also cause device 202 to output an audio part associated with the second portion of the response.

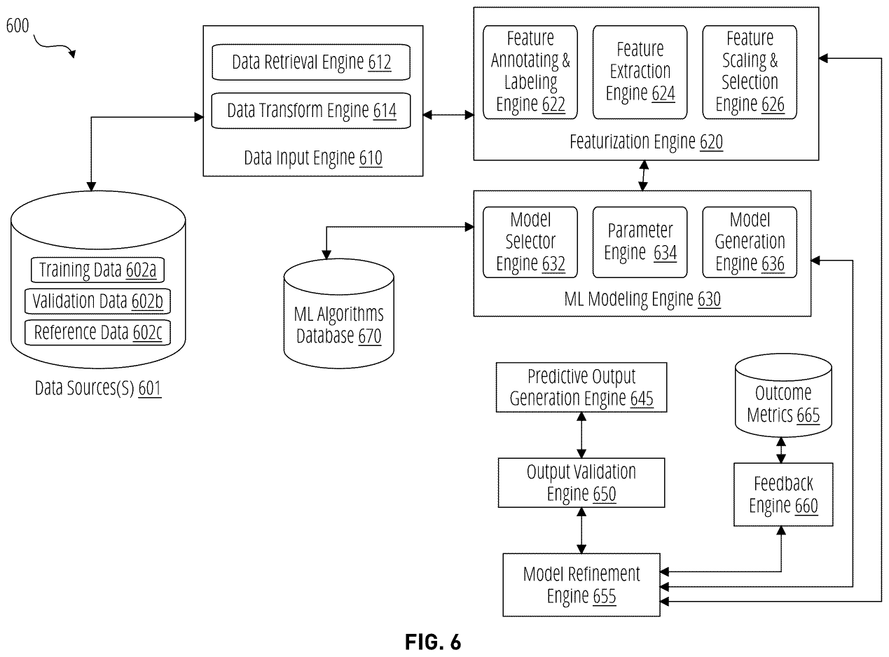

FIG. 6 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 600 may include data input engine 610 that can further include data retrieval engine 612 and data transform engine 614. Data retrieval engine 612 may be configured to access, interpret, request, or receive data, which may be adjusted, reformatted, or changed (e.g., to be interpretable by another engine, such as data input engine 610). For example, data retrieval engine 612 may request data from a remote source using an API. Data input engine 610 may be configured to access, interpret, request, format, re-format, or receive input data from data sources(s) 601. For example, data input engine 610 may be configured to use data transform engine 614 to execute a re-configuration or other change to data, such as a data dimension reduction. In some aspects, data sources(s) 601 may be associated with a single entity (e.g., organization) or with multiple entities. Data sources(s) 601 may include one or more of training data 602a (e.g., input data to feed a machine learning model as part of one or more training processes), validation data 602b (e.g., data against which at least one processor may compare model output with, such as to determine model output quality), and/or reference data 602c. In some aspects, data input engine 610 can be implemented using at least one computing device. For example, data from data sources(s) 601 can be obtained through one or more I/O devices and/or network interfaces. Further, the data may be stored (e.g., during execution of one or more operations) in a suitable storage or system memory. Data input engine 610 may also be configured to interact with a data storage, which may be implemented on a computing device that stores data in storage or system memory.

System 600 may include featurization engine 620. Featurization engine 620 may include feature annotating & labeling engine 622 (e.g., configured to annotate or label features from a model or data, which may be extracted by feature extraction engine 624), feature extraction engine 624 (e.g., configured to extract one or more features from a model or data), and/or feature scaling & selection engine 626 Feature scaling & selection engine 626 may be configured to determine, select, limit, constrain, concatenate, or define features (e.g., AI features) for use with AI models.

System 600 may also include machine learning (ML) ML modeling engine 630, which may be configured to execute one or more operations on a machine learning model (e.g., model training, model re-configuration, model validation, model testing), such as those described in the processes described herein. For example, ML modeling engine 630 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 602a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 630 may include model selector engine 632 (e.g., configured to select a model from among a plurality of models, such as based on input data), parameter engine 634 (e.g., configured to add, remove, and/or change one or more parameters of a model), and/or model generation engine 636 (e.g., configured to generate one or more machine learning models, such as according to model input data, model output data, comparison data, and/or validation data).

In some aspects, model selector engine 632 may be configured to receive input and/or transmit output to ML algorithms database 670. Similarly, featurization engine 620 can utilize storage or system memory for storing data and can utilize one or more I/O devices or network interfaces for transmitting or receiving data. ML algorithms database 670 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 670 can be considered generative response engines.

Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 670 include versions DALL·E, CHAT GPT, and SORA, all provided by OPEN AI.

System 600 can further include predictive output generation engine 645 and output validation engine 650 (e.g., configured to apply validation data to machine learning model output). Predictive output generation engine 645 can analyze the input and identify relevant patterns and associations in the data it has learned to generate a sequence of words that predictive output generation engine 645 predicts is the most likely continuation of the input using one or more models from the ML algorithms database 670, aiming to provide a coherent and contextually relevant answer. Predictive output generation engine 645 generates responses by sampling from the probability distribution of possible words and sequences, guided by the patterns observed during its training. In some aspects, predictive output generation engine 645 can generate multiple possible responses before presenting the final one. Predictive output generation engine 645 can generate multiple responses based on the input, and these responses are variations that predictive output generation engine 645 considers potentially relevant and coherent. Output validation engine 650 can evaluate these generated responses based on certain criteria. These criteria can include relevance to the prompt, coherence, fluency, and sometimes adherence to specific guidelines or rules, depending on the application. Based on this evaluation, output validation engine 650 selects the most appropriate response. This selection is typically the one that scores highest on the set criteria, balancing factors like relevance, informativeness, and coherence.

System 600 can further include feedback engine 660 (e.g., configured to apply feedback from a user and/or machine to a model) and model refinement engine 655 (e.g., configured to update or re-configure a model). In some aspects, feedback engine 660 may receive input and/or transmit output (e.g., output from a trained, partially trained, or untrained model) to outcome metrics database 665. Outcome metrics database 665 may be configured to store output from one or more models and may also be configured to associate output with one or more models. In some aspects, outcome metrics database 665, or other device (e.g., model refinement engine 655 or feedback engine 660), may be configured to correlate output, detect trends in output data, and/or infer a change to input or model parameters to cause a particular model output or type of model output. In some aspects, model refinement engine 655 may receive output from predictive output generation engine 645 or output validation engine 650. In some aspects, model refinement engine 655 may transmit the received output to featurization engine 620 or ML modeling engine 630 in one or more iterative cycles.

The engines of system 600 may be packaged functional hardware units designed for use with other components or a part of a program that performs a particular function (e.g., of related functions). Any or each of these modules may be implemented using a computing device. In some aspects, the functionality of system 600 may be split across multiple computing devices to allow for distributed processing of the data, which may improve output speed and reduce computational load on individual devices. In some aspects, system 600 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 600 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

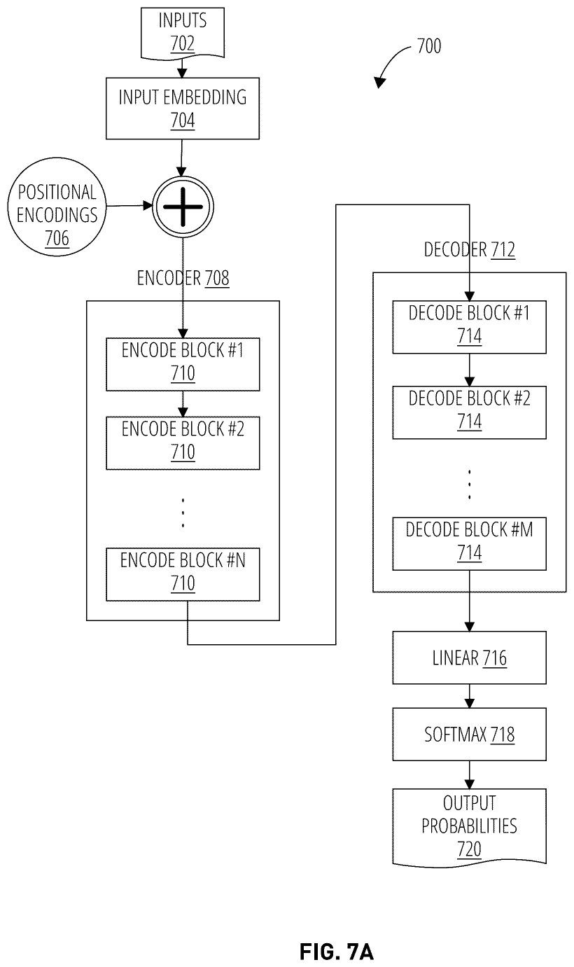

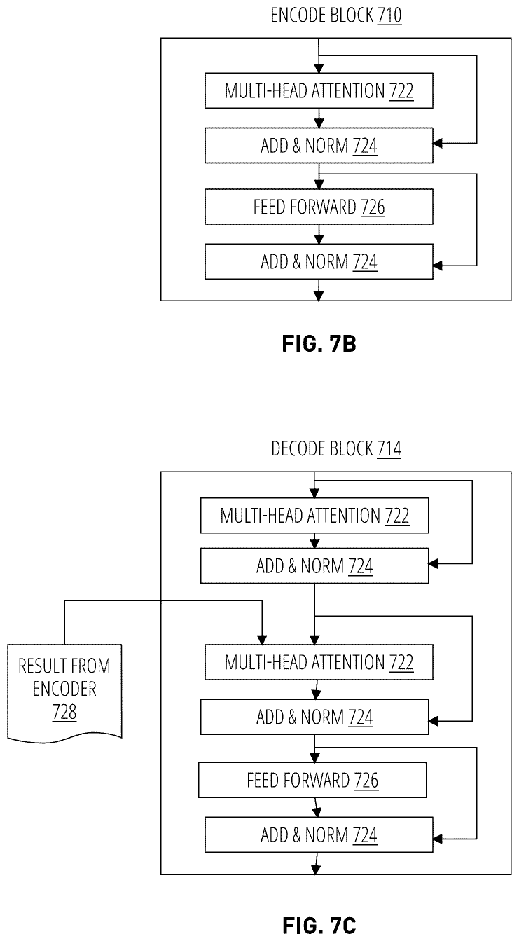

FIG. 7A, FIG. 7B, and FIG. 7C illustrates an example transformer architecture in accordance with some aspects of the present technology. Examples of ML models that use a transformer neural network (e.g., transformer architecture 700) can include, e.g., generative pretrained transformer (GPT) models and Bidirectional Encoder Representations from Transformer (BERT) models. The transformer architecture 700, which is illustrated in FIG. 7A, FIG. 7B, and FIG. 7C, includes inputs 702, input embedding block 704, positional encodings 706, encoder 708 including encode blocks 710, decoder 712 including decode blocks 714, linear block 716, softmax block 718, and output probabilities 720.

Input embedding block 704 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 704 can be learned embeddings to convert the input tokens and output tokens to vectors of dimension that have the same dimension as the positional encodings, for example.

Positional encodings 706 provide information about the relative or absolute position of the tokens in the sequence. According to certain non-limiting examples, positional encodings 706 can be provided by adding positional encodings to the input embeddings at the inputs to the encoder 708 and decoder 712. The positional encodings have the same dimension as the embeddings, thereby enabling a summing of the embeddings with the positional encodings.

There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 708 can use stacked self-attention and point-wise, fully connected layers. Encoder 708 can be a stack of N identical layers (e.g., N=6), and each layer can be an encode block, as illustrated by encode block 710 shown in FIG. 7B. Each encode block 710 has two sub-layers: (i) a first sub-layer has a multi-head attention block 722 and (ii) a second sub-layer has a feed forward block 726, which can be a position-wise fully connected feed-forward network. The feed forward block 726 can use a rectified linear unit (ReLU).

Encoder 708 uses a residual connection around each of the two sub-layers, followed by an add & norm block 724, which performs normalization. For example, the output of each sub-layer can be LayerNorm(x+Sublayer(x)). To facilitate these residual connections, all sub layers in the model, as well as the embedding layers, produce output data having a same dimension.

Similar to encoder 708, decoder 712 uses stacked self-attention and point-wise, fully connected layers. Decoder 712 can also be a stack of M identical layers (e.g., M=6), and each layer can be a decode block, as illustrated by decode block 712 shown in FIG. 7B. In addition to the two sub-layers (i.e., the sublayer with multi-head attention block 722 and the sub-layer with feed forward block 726) found in encode block 710, decode block 714 can include a third sub-layer, which performs multi-head attention over the output of the encoder stack. Similar to encoder 708, decoder 712 uses residual connections around each of the sub-layers, followed by layer normalization. Additionally, the sub-layer with multi-head attention block 722 can be modified in the decoder stack to prevent positions from attending to subsequent positions. This masking, combined with the fact that the output embeddings are offset by one position, can ensure that the predictions for position i can depend only on the known output data at positions less than i.

Linear block 716 can be a learned linear transformation. For example, when transformer architecture 700 is being used to translate from a first language into a second language, linear block 716 can project the output from the last decode softmax block 718 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 718 then turns the scores from linear block 716 into output probabilities 720 (which add up to 1.0). In each position, the index provides for the word with the highest probability, and then maps that index to the corresponding word in the vocabulary. Those words then form the output sequence of transformer architecture 700. The softmax operation is applied to the output from linear block 716 to convert the raw numbers into output probabilities 720 (e.g., token probabilities).

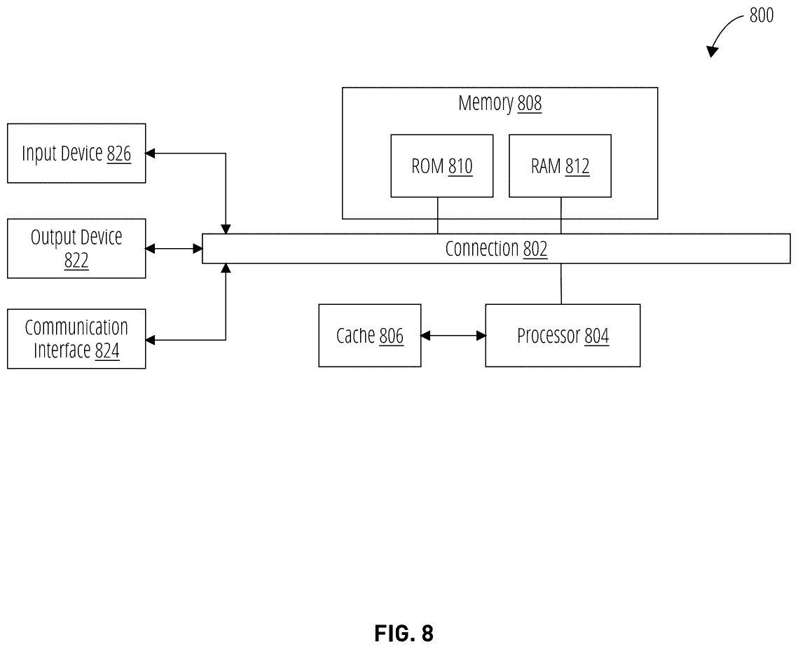

FIG. 8 shows an example of computing system 800, which can be, for example, any computing device making up any engine illustrated in FIG. 1 or any component thereof.

In some aspects, computing system 800 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 800 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 800 includes at least one processing unit (CPU or processor) 804 and connection 802 that couples various system components including system memory 808, such as read-only memory (ROM) 810 and random access memory (RAM) 812 to processor 804. Memory 808 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 808 can include software services, servers, logic, etc., that when the code that defines such software is executed by the processor 804, it causes the system to perform a function. In some aspects, a hardware service that performs a particular function can include the software component stored in a computer-readable medium in connection with the necessary hardware components, such as processor 804, connection 802, output device 822, etc., to carry out the function.

Computing system 800 can include a cache of high-speed memory 806 connected directly with, in close proximity to, or integrated as part of processor 804.

Connection 802 can be a physical connection via a bus, or a direct connection into processor 804, such as in a chipset architecture. Connection 802 can also be a virtual connection, networked connection, or logical connection.

Processor 804 can include any general purpose processor and a hardware service or software service stored in memory 808, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi core processor may be symmetric or asymmetric. Processor 804 can be physcial or virtual.

To enable user interaction, computing system 800 includes an input device 826, which can represent any number of input mechanisms, such as a microphone for speech, a touch-sensitive screen for gesture or graphical input, keyboard, mouse, motion input, speech, etc.

Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

In some aspects, computing system 800 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

Aspect 1: A method comprising: receiving, by a front end to a generative response engine, a prompt from a user account, wherein the generative response engine is a multi-modal generative response engine, wherein the generative response engine is configured to receive or output text, images, and/or audio, wherein the generative response engine is a generative pre-trained transformer; sending, by the front end, the prompt to the generative response engine; generating, by the generative response engine, at least a first portion of a response to the prompt, wherein the at least the first portion of the response includes a visual part of the response and a spoken text part that corresponds to the visual part of the response, wherein the visual part of the response is provided in markup language to be rendered by the front end, wherein the visual part of the response is a video to be played by the front end, wherein the spoken text part is provided as text to be converted to speech and played by the front end, wherein the spoken part is provided as audio to be played by the front end; sending, by the generative response engine to the front end, the at least the first portion of the response to the front end; rendering, by the front end, the visual part of the at least the first portion of the response by the front end in a graphical user interface and playing the spoken text that corresponds to the first portion of the response.

Aspect 2: The method of Aspect 1, wherein the sending the at least the first portion of the response to the front end includes streaming the at least the first portion of the response to the front end as it is generated.

Aspect 3: The method of any of Aspects 1-2, wherein the sending the at least the first portion of the response to the front end includes streaming the at least the first portion of the response to the front end as it is generated.

Aspect 4: The method of any of Aspects 1-3, wherein the first portion of the response includes instructions to the front end to display the visual part of the response in a first state at a first time that corresponds to a first spoken text part, and instructions to progress the visual part of the response to a second state at a second time that corresponds to a second spoken text part.

Aspect 5: The method of any of Aspects 1-4, wherein the graphical user interface comprises a first portion for displaying the visual part of the response and a second portion for displaying the text that at least summarizes the spoken text.

Aspect 6: The method of any of Aspects 1-5, further comprising: determining, by the generative response engine, an intended response type of the prompt; and generating, by the generative response engine, the at least the first portion of the response to include content of the response in a format of the intended response type.

Aspect 7: The method of any of Aspects 1-6, wherein selectively rendering the visual part of the at least the first portion of the response in the graphical user interface comprises: outputting, by the generative response engine, a type of display for displaying the visual part of the at least the first portion of the response based on the intended response type; and outputting, by the generative response engine, the visual part of the at least the first portion of the response for rendering a display by the front end, wherein the display comprises the content formatted in the type of display.

Aspect 8: The method of any of Aspects 1-7, further comprising: based on the determination of a type of display, causing, by the generative response engine, the front end to render the type of display in an interactive interface.

Aspect 9: The method of any of Aspects 1-8, further comprising: accessing, by the generative response engine, a thread comprising the prompt and the response, wherein the thread provides context for outputting the visual part of the at least the first portion of the response.

Aspect 10: The method of any of Aspects 1-9, further comprising: outputting, by the generative response engine, executable code for rendering interactive content comprising the at least the first portion of the response such that the user account can multimodally interact with the interactive content.

Aspect 11: The method of any of Aspects 1-10, wherein the executable code for rendering interactive content comprises markup code of a series of panels that can be paged through.

Aspect 12: The method of any of Aspects 1-11, wherein the generative response engine advances to a subsequent panel of the series of panels as the spoken text is played.

Aspect 13: The method of any of Aspects 1-12, wherein the series of panels is advanced by the front end based on input from the user account.

Aspect 14: The method of any of Aspects 1-13, further comprising: receiving, by the generative response engine, an indication, from the front end, that the user account has advanced to a subsequent panel; and causing, by the generative response engine, the front end to play a portion of the spoken text corresponding to the subsequent panel, wherein the subsequent panel displays content of the at least the first portion of the response.

Aspect 15: The method of any of Aspects 1-14, further comprising: receiving, by the front end, a selection of a segment of the at least the first portion of the response displayed via the graphical user interface; determining, by the front end, contents of the segment based on an area of pixels selected by the user account interacting with the graphical user interface; providing, by the front end to the generative response engine, a second prompt comprising the contents of the segment; receiving, by the front end, a second output from the generative response engine based on the second prompt, wherein the second output comprises a second response; and displaying, by the front end, the second response via the graphical user interface.

Aspect 16: The method of any of Aspects 1-15, further comprising: capturing, by the front end, a first screenshot of a display of graphical user interface; receiving, by the front end, a manipulation of the graphical user interface by a user, thereby generating a modified display of the graphical user interface; based on the receiving, capturing, by the front end, a second screenshot of the modified display; providing, by the front end to the generative response engine, the first screenshot and the second screenshot; outputting, by the generative response engine, at least a second portion of the response based on a change in the display captured between the first screenshot and the second screenshot; receiving, by the front end, the at least the second portion of the response; and displaying, by the front end, a visual part of the second response via the graphical user interface.

Aspect 17. A non-transitory computer-readable medium having stored thereon instructions that, when executed by at least one processor, cause the at least one processor to perform operations according to any of Aspects 1 to 16.

Aspect 18. A computing system for performing a function, comprising one or more means for performing operations according to any of Aspects 1 to 16.

Aspect 19: A method comprising: presenting, by the front end, a visual part of at least the first portion of a response to a prompt and first text that corresponds to the first portion of the response; receiving, at the front end, an interaction by a user of the user account with an interactive element of the visual part of the at least the first portion of the response; after the interaction, presenting, by the front end, a visual part of the second portion of the response and second text that corresponds to the second portion of the response.

Aspect 20: The method of Aspect 19, wherein the first text that corresponds to the first portion of the response, and the second text that corresponds to the second portion of the response are spoken text.

Aspect 21: The method of any of Aspects 19-20, wherein the first portion and the second portion of the response to the prompt were generated by a generative response engine prior to presenting the first portion of the response.

Aspect 22: The method of any of Aspects 19-21, further comprising: sending, by the front end, first data resulting from the interaction to the generative response engine; receiving, by the front end, from the generative response engine, the second portion of the response.

Aspect 23: The method of any of Aspects 19-22, wherein the first data comprises a screenshot of the graphical user interface after the interaction that is indicative of the interaction with the graphical user interface by the user and useable as context for the generative response engine for outputting the second portion of the response.

Aspect 24: The method of any of Aspects 19-23, wherein the visual part of the at least first portion of the response is configured to: be rendered by the front end to display a high-level summary based on the response, wherein the high-level summary is formatted into a set of content elements, wherein a content element is associated with content of the response associated with a sub-topic.

Aspect 25: The method of any of Aspects 19-24, wherein receiving, at the front end, an interaction by the user comprises: receiving, via the graphical user interface, first data resulting from the interaction, wherein the first data corresponds, at least in part, to a first content element of the set of content elements.

Aspect 26: The method of any of Aspects 19-25, further comprising: generating, by the front end, a textual prompt by: determining, by the front end, the first content element based on the first data, thereby determining a sub-topic selection of the user; and generating, by the front end, the textual prompt, wherein the textual prompt comprises a request for information on the sub-topic.

Aspect 27: The method of any of Aspects 19-26, wherein receiving, at the front end, the interaction by the user comprises: receiving, via a microphone of the device, audio data comprising a verbal command spoken by the user; and providing, by the front end, the audio data to the generative response engine.

Aspect 28. A non-transitory computer-readable medium having stored thereon instructions that, when executed by at least one processor, cause the at least one processor to perform operations according to any of Aspects 19 to 27.

Aspect 29. A computing system for performing a function, comprising one or more means for performing operations according to any of Aspects 19 to 27.

The present technology includes computer-readable storage mediums for storing instructions, and systems for executing any one of the methods embodied in the instructions addressed in the aspects of the present technology presented below:

1. A method comprising:
receiving, by a front end to a multi-modal generative response engine, a prompt from a user account;
generating, by the multi-modal generative response engine, tokens comprising at least a first portion of a response to the prompt, wherein the at least the first portion of the response includes a visual part and a spoken text part, wherein the visual part comprises a stream of text tokens, and wherein the spoken text part comprises a stream of audio tokens, wherein the spoken text part of the response corresponds to the visual part of the response, and wherein the text tokens comprise instructions for rendering the visual part and offset information generated by the generative response engine and included in the stream of text tokens for synchronizing the visual part and the spoken text part;
sending, by the multi-modal generative response engine to the front end, the at least the first portion of the response to the front end; and
rendering, by the front end, the visual part of the at least the first portion of the response by the front end in a graphical user interface using the instructions of the text tokens and playing the spoken text that corresponds to the first portion of the response based on the offset information in the stream of text tokens.

2. The method of claim 1, wherein the sending the at least the first portion of the response to the front end includes streaming the at least the first portion of the response to the front end as it is generated.

3. (canceled)

4. The method of claim 1, wherein the first portion of the response includes instructions to the front end to display the visual part of the response in a first state at a first time that corresponds to a first spoken text part, and instructions to progress the visual part of the response to a second state at a second time that corresponds to a second spoken text part.

5. The method of claim 1, wherein the graphical user interface comprises a first portion for displaying the visual part of the response and a second portion for displaying the text that at least summarizes the spoken text.

6. The method of claim 1, further comprising:
outputting, by the multi-modal generative response engine, executable code for rendering interactive content comprising the at least the first portion of the response such that the user account can multimodally interact with the interactive content.

7. A computing system comprising:
at least one processor; and
a memory storing instructions that, when executed by the at least one processor, configure the computing system to:
receive, by a front end to a multi-modal generative response engine, a prompt from a user account;
generate, by the multi-modal generative response engine, tokens comprising at least a first portion of a response to the prompt, wherein the at least the first portion of the response includes a visual part and a spoken text part, wherein the visual part comprises a stream of text tokens, and wherein the spoken text part of the response comprises a stream of audio tokens, wherein the spoken text part of the response corresponds to the visual part of the response, and wherein the text tokens comprise instructions for rendering the visual part and offset information generated by the generative response engine and included in the stream of text tokens for synchronizing the visual part and the spoken text part;
send, by the multi-modal generative response engine to the front end, the at least the first portion of the response to the front end; and
render, by the front end, the visual part of the at least the first portion of the response by the front end in a graphical user interface using the instructions of the text tokens and playing the spoken text that corresponds to the first portion of the response based on the offset information in the stream of text tokens.

8. The computing system of claim 7, wherein the instructions further configure the computing system to:
output, by the multi-modal generative response engine, executable code for rendering interactive content comprising the at least the first portion of the response such that the user account can multimodally interact with the interactive content.

9. The computing system of claim 8, wherein the executable code for rendering interactive content comprises markup code of a series of panels that can be paged through.

10. The computing system of claim 9, wherein the multi-modal generative response engine advances to a subsequent panel of the series of panels as the spoken text is played.

11. The computing system of claim 9, wherein the series of panels is advanced by the front end based on input from the user account.

12. The computing system of claim 11, wherein the instructions further configure the computing system to:
receive, by the multi-modal generative response engine, an indication, from the front end, that the user account has advanced to a subsequent panel; and
cause, by the multi-modal generative response engine, the front end to play a portion of the spoken text corresponding to the subsequent panel, wherein the subsequent panel displays content of the at least the first portion of the response.

13. The computing system of claim 8, wherein the instructions further configure the computing system to:
receive, by the front end, a selection of a segment of the at least the first portion of the response displayed via the graphical user interface;
determine, by the front end, contents of the segment based on an area of pixels selected by the user account interacting with the graphical user interface;
provide, by the front end to the multi-modal generative response engine, a second prompt comprising the contents of the segment;
receive, by the front end, a second output from the generative response engine based on the second prompt, wherein the second output comprises a second response; and
display, by the front end, the second response via the graphical user interface.

14. The computing system of claim 8, wherein the instructions further configure the computing system to:
capture, by the front end, a first screenshot of a display of graphical user interface;
receive, by the front end, a manipulation of the graphical user interface by a user, thereby generating a modified display of the graphical user interface;
based on the receiving, capture, by the front end, a second screenshot of the modified display;
provide, by the front end to the multi-modal generative response engine, the first screenshot and the second screenshot;
output, by the multi-modal generative response engine, at least a second portion of the response based on a change in the display captured between the first screenshot and the second screenshot;
receive, by the front end, the at least the second portion of the response; and
display, by the front end, a visual part of the second response via the graphical user interface.

15. A non-transitory computer-readable medium comprising instructions that when executed by at least one processor, cause the at least one processor to:
receive, by a front end to a multi-modal generative response engine, a prompt from a user account;
generate, by the multi-modal generative response engine, tokens comprising at least a first portion of a response to the prompt, wherein the at least the first portion of the response includes a visual part and a spoken text part, wherein the visual part comprises a stream of text tokens, and wherein the spoken text part of the response comprises a stream of audio tokens, wherein the spoken text part of the response corresponds to the visual part of the response, and wherein the text tokens comprise instructions for rendering the visual part and offset information generated by the generative response engine and included in the stream of text tokens for synchronizing the visual part and the spoken text part;
send, by the multi-modal generative response engine to the front end, the at least the first portion of the response to the front end; and
render, by the front end, the visual part of the at least the first portion of the response by the front end in a graphical user interface using the instructions of the text tokens and playing the spoken text that corresponds to the first portion of the response based on the offset information in the stream of text tokens.

16. The non-transitory computer-readable medium of claim 15, wherein the instructions further configure the at least one processor to:
output, by the multi-modal generative response engine, executable code for rendering interactive content comprising the at least the first portion of the response such that the user account can multimodally interact with the interactive content.

17. The non-transitory computer-readable medium of claim 15, wherein the instructions further configure the at least one processor to:
determine, by the multi-modal generative response engine, an intended response type of the prompt; and
generate, by the multi-modal generative response engine, the at least the first portion of the response to include content of the response in a format of the intended response type.

18. The non-transitory computer-readable medium of claim 17, wherein selectively rendering the visual part of the at least the first portion of the response in the graphical user interface comprises:
outputting, by the multi-modal generative response engine, a type of display for displaying the visual part of the at least the first portion of the response based on the intended response type; and
outputting, by the multi-modal generative response engine, the visual part of the at least the first portion of the response for rendering a display by the front end, wherein the display comprises the content formatted in the type of display.

19. The non-transitory computer-readable medium of claim 15, wherein the instructions further configure the at least one processor to:
based on the determination of a type of display, cause, by the multi-modal generative response engine, the front end to render the type of display in an interactive interface.

20. The non-transitory computer-readable medium of claim 19, wherein the instructions further configure the at least one processor to:
access, by the multi-modal generative response engine, a thread comprising the prompt and the response, wherein the thread provides context for outputting the visual part of the at least the first portion of the response.

21. The method of claim 1, wherein the stream of text tokens comprises a subset of information of the stream of audio tokens.
